(19) United States
(12) Patent Application Publication
(10) Pub. No.: US 2010/0107125 A1
(43) Pub. Date: Apr. 29, 2010

(54) Light Box for Organizing Digital Images

(75) Inventors: Lawrence M. Ockene, Seattle, WA (US); Craig Anthony Osborne, Issaquah, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/257,796

(22) Filed: Oct. 24, 2008

(51) Int. Cl. G06F 3/048

(52) U.S. Cl. 715/838

(57) ABSTRACT

A processing device and a machine-implemented method may be provided for assisting users of photographic applications to organize large numbers of digital images. A light box may be a conceptual workspace having a number of digital images positioned on a surface thereof. A user may select one of a number of light boxes and a portion of a surface of the selected one of the light boxes may be displayed along with a navigation panel. The navigation panel may provide an indication of where the displayed portion of the surface of the selected one of the light boxes is located with respect to a complete surface of the light box. Digital images may be automatically grouped or manually grouped. A filtering capability may be provided to filter digital images on a surface of a light box based on one or more specified criteria.

### BACKGROUND

Digital photography is easier and less expensive relative to older photographic methods. As a result, many professional photographers and serious amateur photographers have collections of hundreds of thousands of digital images. Photographers have difficulty organizing large quantities of digital images and finding images of interest among the large quantities of digital images.

Existing photographic software applications provide organizing and searching tools to assist photographers who wish to organize digital images or search for particular digital images. The tools may use metadata, such as, for example, keywords, titles, ratings, or other metadata, as well as organizational tools for creating hierarchical folders and collections of digital images. However, photographers tend to be visual and tactile and most photographers do not bother to tag digital images in a way that would make the digital images easy to find. Further, most photographic software applications do not provide a natural, organic, and spatial way to organize and group digital images.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

A method and a processing device may be provided for assisting users of photographic applications to organize large numbers of digital images. A light box may be a conceptual workspace having a number of digital images positioned on a surface thereof. Embodiments consistent with the subject matter of this disclosure may have multiple light boxes. A user may browse the light boxes via a light box browsing display. The user may select one of the light boxes from the light box browsing display or the user may select one of the light boxes from a menu of light boxes.

After selecting one of the light boxes, a portion of a surface of the selected one of the light boxes may be displayed along with a navigation panel. The portion of the surface may have a number of digital images positioned thereon. The navigation panel may include a miniature view of a complete surface of the light box. A navigation indicator of the navigation panel may indicate where the displayed portion of the surface of the selected one of the light boxes is located with respect to the complete surface of the light box. In some embodiments, the navigation indicator may be used to pan a surface of a light box. A zooming capability may provide a number of zoom levels for zooming in (enlarging) or zooming out (shrinking) a displayed surface of a light box.

Digital images of a light box may be sorted according to selected criteria, such as, for example, a capture or shoot date of respective digital images, a date the respective digital images were transferred to a processing device, a name of the respective digital images, user-provided metadata of the respective digital images, or other criteria. The user-provided metadata may include one or more keywords.

In embodiments consistent with the subject matter of this disclosure, a user may search all digital images of a light box for digital images associated with a particular keyword, or group of keywords. Further, in some embodiments, a user may search across multiple light boxes for digital images associated with a one or more particular keywords, or group of keywords. As a result of a search, digital images having the particular keyword, or group of keywords may be displayed.

A light box may have associated metadata, which may include, but not be limited to, an aggregation of all metadata associated with digital images included in the light box and additional metadata, such as light box specific data. A search result may include one or more light boxes having metadata matching one or more keywords of a search.

Digital images may be automatically grouped or manually grouped. A filtering capability may be provided to filter digital images on a surface of a light box based on one or more specified criteria. A digital image or groups of digital images may be added to or removed from existing groups of digital images by use of a pointing device. A user may assign respective rankings to individual digital images or groups of digital images. Multiple digital images or a group of digital images may be categorized into a number of groups of digital images based on user-provided input.

### DRAWINGS

In order to describe the manner in which the above-recited and other advantages and features can be obtained, a more particular description is described below and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 is a functional block diagram of an exemplary processing device, which may be used to implement embodiments consistent with subject matter of this disclosure.

FIG. 2 illustrates an exemplary light box, which may be used in embodiments consistent with the subject matter of this disclosure.

FIG. 3 illustrates an example of a menu from which a user may select a light box in embodiments consistent with the subject matter of this disclosure.

FIG. 4 is an example of a light box browsing display for browsing a number of light boxes.

FIG. 5 illustrates an exemplary display of a portion of a surface of a light box and an exemplary navigation panel.

FIG. 6 is an exemplary display for use in illustrating manual formation of groups of digital images in embodiments consistent with the subject matter of this disclosure.

FIG. 7 is an exemplary display for use in illustrating automatic formation of groups of digital images in embodiments consistent with the subject matter of this disclosure.

FIG. 8 is an exemplary display for illustrating adding of a first group of digital images to a second group of digital images.

FIG. 9 is an exemplary display for categorizing digital images of a group of digital images into a number of groups of digital images.

FIG. 10 illustrates exemplary menus and menu items for indicating a desire to sort digital images and for selecting a sorting criteria.

FIG. 11 is an exemplary display illustrating filtering of digital images in an embodiment consistent with the subject matter of this disclosure.

FIG. 12 is an exemplary display illustrating creation of a hot spot and assignment of a workflow to the hotspot.

FIG. 13 is an exemplary display illustrating ranking of a digital image in an embodiment consistent with the subject matter of this disclosure.

FIG. 14 is an exemplary display illustrating ranking of a group of digital images in an embodiment consistent with the subject matter of this disclosure.

FIG. 15 illustrates an exemplary keyword search and an exemplary display of a search result including digital images having metadata matching one or more keywords of the search.

FIG. 16 is an exemplary flow of actions that may be performed during a user session in embodiments consistent with the subject matter of this disclosure.

### DETAILED DESCRIPTION

Embodiments are discussed in detail below. While specific implementations are discussed, it is to be understood that this is done for illustration purposes only. A person skilled in the relevant art will recognize that other components and configurations may be used without parting from the spirit and scope of the subject matter of this disclosure.

### Overview

A machine-implemented method and a processing device are provided for assisting users, such as, for example, photographers, or other users, to organize large numbers of digital images, and to find digital images of interest. In embodiments consistent with the subject matter of this disclosure, a number of digital images may be associated with respective conceptual workspaces, which may be called light boxes. The digital images associated with a light box may be displayed as appearing on a surface of the light box. A light box may have as little as one associated digital image, many hundreds of thousands of digital images, or any other number of digital images.

A user may select one of the light boxes by browsing a number of light boxes and making a selection, by selecting a light box from a list of light boxes, or by other methods. After selecting a light box, a portion of the selected light box may be displayed, or the complete selected light box may be displayed. If the selected light box has a large number of associated digital images, each of the digital images may appear to be no larger than a speck when the complete selected light box is displayed. A zooming capability may provide a number of zoom levels for enlarging or shrinking a display of a surface of a complete light box, or a display of a portion of the surface of the light box.

Digital images on a surface of a light box may be displayed in a number of different formations, such as, for example, a grid, a stack, a sorted formation, and a custom formation. A user may move one or more digital images on the surface of the light box by using a pointing device and selecting and dragging the one or more digital images to another position. Other methods may also be used to move digital images.

Digital images may be grouped automatically, according to specific criteria, such as, for example, creation date, a date a digital image was transferred to a processing device, a digital image filename, user-defined criteria, or other criteria. A facility may be provided for a user to group and name digital images. For example, in one embodiment, a user may employ a pointing device to select an area having multiple digital images, in order to form a group which includes the multiple digital images. One or more images may be added or removed from groups by moving the one or more images.

A filtering capability may be provided to filter digital images associated with a light box based on one or more criteria. The digital images may be filtered based on creation date, transfer date, image filename, or other criteria. Digital images that satisfy filtering criteria may be indicated visually. For example, digital images that satisfy the filtering criteria may appear to be brighter than digital images that do not satisfy the filtering criteria. In some embodiments, the digital images that do not satisfy the filtering criteria may be hidden, or not displayed.

A navigation panel may be displayed along with a portion of a light box. The navigation panel may include a miniature rendering of a complete light box, and an indicator indicating a position of the displayed portion of the light box with respect to the complete light box. The navigation panel may further provide a user interface for panning a surface of the light box.

Each digital image of a light box may be inspected individually and edited. Further, digital images may be ranked individually, or as groups of digital images.

### Exemplary Processing Device

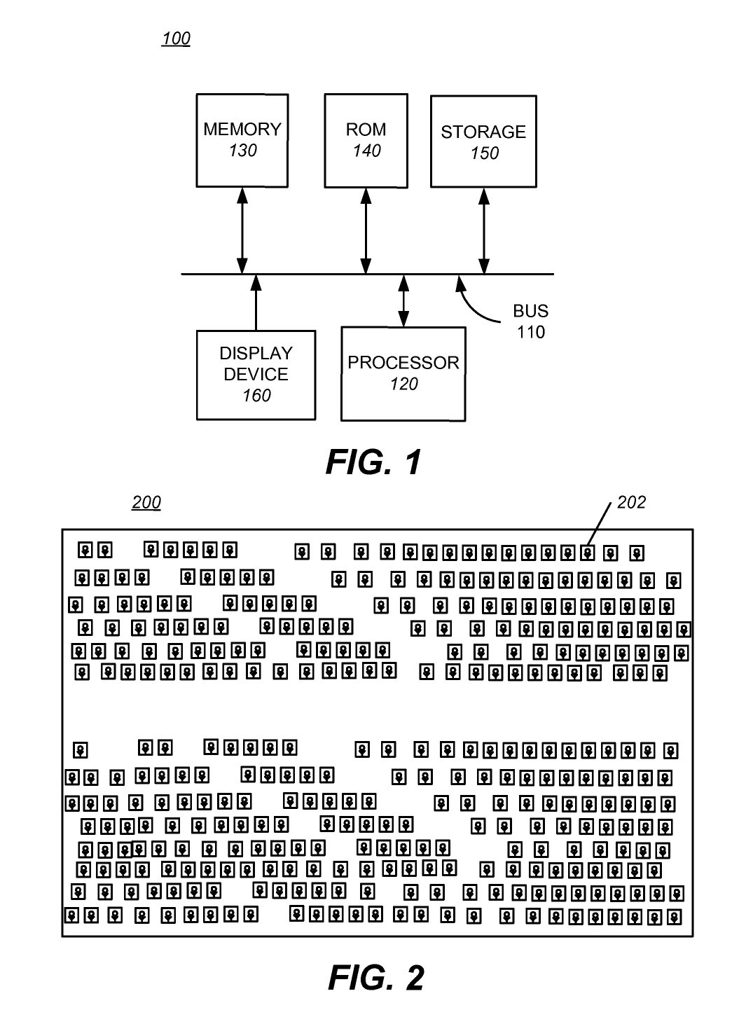

FIG. 1 is a functional block diagram of an exemplary processing device 100, which may be used to implement embodiments consistent with the subject matter of this disclosure. Processing device 100 may be a desktop personal computer (PC), a notebook or laptop PC, a server, or other processing device. Processing device 100 may include a bus 110, a memory 130, a read only memory (ROM) 140, a processor 120, a storage device 150, and a display device 160. Bus 110 may permit communication among components of processing device 100.

Processor 120 may include at least one conventional processor or microprocessor that interprets and executes instructions. Memory 130 may be a random access memory (RAM) or another type of dynamic storage device that stores information and instructions for execution by processor 120. Memory 130 may store temporary variables or other intermediate information used during execution of instructions by processor 120. ROM 140 may include a conventional ROM device or another type of static storage device that stores static information and instructions for processor 120. Storage device 150 may include a hard disk and corresponding drive, a flash-based storage device, or other type of data storage device or medium for storing data and/or instructions for processor 120. Display device 160 may include a monitor, such as, for example, a cathode ray tube (CRT) display, a liquid crystal display (LCD), a plasma display, or other type of display. In some embodiments, display device 160 may include a touch screen.

Processing device 100 may perform functions in response to processor 120 executing sequences of instructions contained in a tangible machine-readable medium, such as, for example, memory 130, ROM 140, storage device 150 or other medium. Such instructions may be read into memory 130 from another machine-readable medium or from a separate device via a communication interface (not shown).

### Light Boxes

FIG. 2 is an exemplary display of a light box 200. Light box 200 may include a number of digital images 202. Digital images 202 may be digital images of varying sizes and orientations. For example, some of digital images 202 may be larger or smaller than others of digital images 202. Further, some of digital images 202 may be more long than wide and others of digital images 202 may be more wide than long.

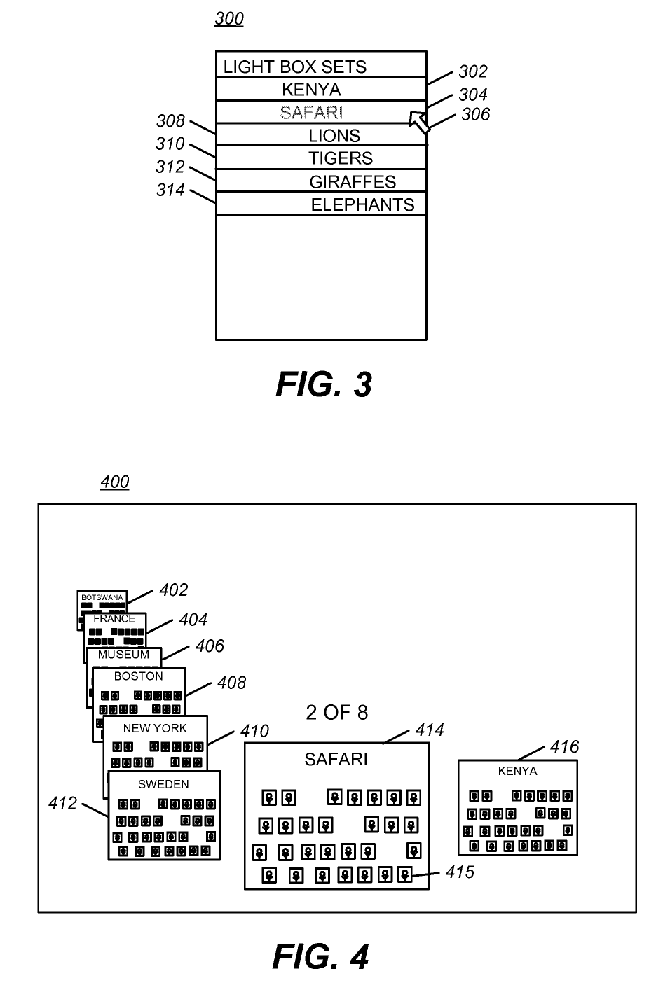

A light box may be selected from a number of light boxes in a number of different ways. FIG. 3 shows an exemplary menu 300, from which a user may select a light box. Exemplary menu 300 lists two menu items representing respective light boxes, a first menu item 302 representing a light box named Kenya, and a second menu item 304 representing a light box named Safari. The user may select a desired light box by using a pointing device, which may be a computer mouse, a stylus, an electronic pen, a user's finger, or other pointing device. The user may select one of the light boxes by placing the pointing device over one of menu items 302, 304 including a name of a desired light box, which may cause one of menu items 302, 304 to be highlighted or shaded, as shown in FIG. 3. In some embodiments, the names of groups of digital images, included in the desired light box, may be displayed when the pointing device is placed over one of menu items 302, 304 corresponding to the desired light box. For example, FIG. 3 displays the names of groups Lions 308, Tigers 310, Giraffes 312, and Elephants 314 when the pointing device is placed over menu item 304.

The user may select the desired light box by touching one of menu items 302, 304, corresponding to the desired light box, with the pointing device, by clicking on one of menu items 302, 304, corresponding to the desired light box, with the pointing device, or by another method. FIG. 3 further illustrates a cursor 306, which may be displayed when using, for example, a computer mouse.

Although exemplary menu 300 shows two menu items corresponding to respective light boxes, embodiments consistent with the subject matter of this disclosure may include fewer than two light boxes or more than two light boxes. Similarly, exemplary menu 300 indicates that the light box named Safari includes four groups of digital images. However, embodiments consistent with the subject matter of this disclosure may include light boxes with fewer than four groups of digital images, or more than four groups of digital images.

Embodiments consistent with the subject matter of this disclosure may include a light box browsing capability for browsing light boxes. FIG. 4 illustrates an exemplary display 400 for browsing light boxes. Exemplary display 400 shows eight light boxes 402-416, being displayed as respective planes. Light box 414 is a light box currently being browsed. Thumbnail images 415, representing at least some of a number of digital images of light box 414, may be displayed on a surface of light box 414, currently being browsed. A user may browse any other light box by selecting a different light box. The different light box may be selected by tapping on any of light boxes 402-412 and 416 with a pointing device, clicking on the different light box with the pointing device, or via other methods. Although exemplary display 400 shows eight light boxes, fewer or more than eight light boxes may be represented in a browsing display.

Various embodiments may provide a facility for a user to rename a light box. In one embodiment, with respect to FIG. 3, the user may right-click, using a computer mouse, on one of menu items 302, 304, 306 to cause a pop-up menu to be displayed. A second pop-up menu, which may include a menu item for renaming a light box may then be displayed. The user may select the menu item for renaming the light box and may be prompted for a new name for the light box. Similarly, the user may right-click, using a computer mouse, on one of light boxes 402, 404, 406, 408, 410, 412, 414, 416 (FIG. 4). A second pop-up menu, as just described with respect to FIG. 3, may be displayed, from which the user may select the menu item for renaming the light box. Of course, in embodiments consistent with the subject matter of this disclosure, other methods may be employed for renaming a light box.

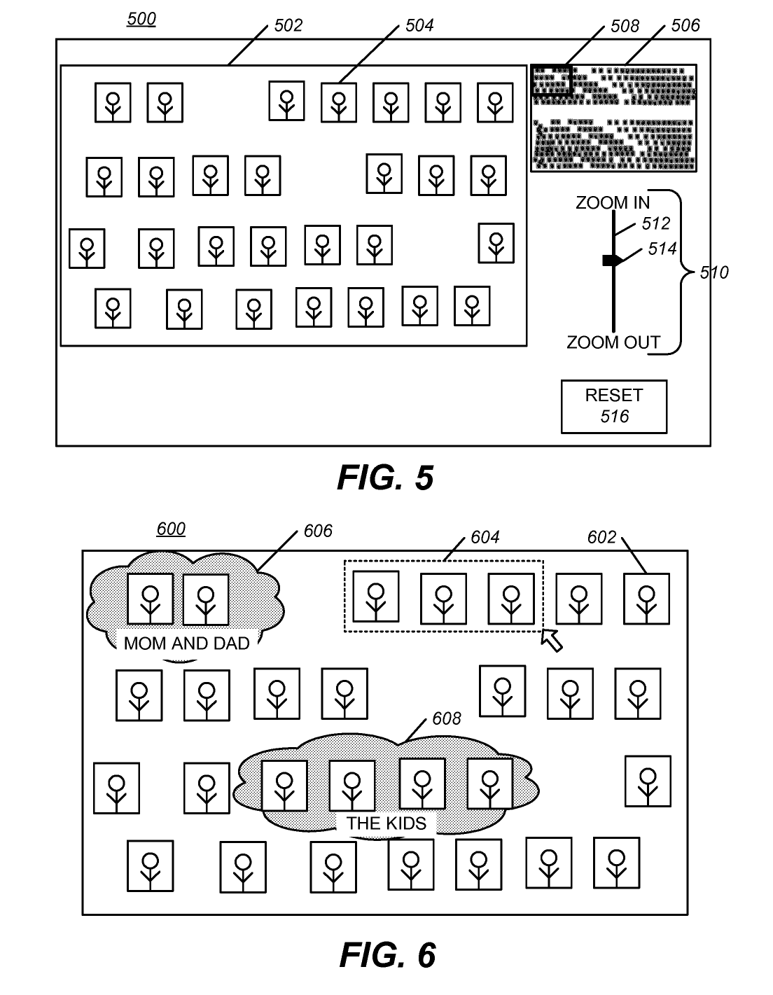

FIG. 5 illustrates an exemplary display 500 of an embodiment consistent with the subject matter of this disclosure. Exemplary display 500 may include at least a portion of a surface of a light box 502 including digital images 504. Navigation panel 506 may provide a miniature complete view of light box 502. Navigation indicator 508 of navigation panel 506 may surround a portion of the miniature complete view of light box 502 corresponding to the portion of the surface of light box 502 shown in exemplary display 500. Thus, navigation panel 506 may provide a user with a sense of where the displayed portion of the surface of light box 502 is a located with respect to the surface of light box 502 in its entirety.

In some embodiments, a user may pan light box 502 by selecting navigation indicator 508, via a pointing device or other method, and dragging navigation indicator 508. Alternatively, the user may select, via a pointing device, a surface of the light box and may drag the surface to pan the light box. Of course, in other embodiments, other methods may be employed for panning a light box.

In some embodiments, navigation panel 506 may provide a visual indication to indicate portions of light box 502 that have already been viewed. For example, the visual indication may be shading of the portions of light box 502 that have already been viewed. In other embodiments, another visual indication may be employed to indicate previously viewed portions of a light box. A user may reset the visual indication by selecting a reset control 516. Thus, for example, the user may jump all around a light box, perusing digital images in an ad hoc manner. A visual indication may indicate ones of the digital images viewed. The user may then reset the visual indication by selecting reset control 516 and may again view digital images, but in a more methodical manner, such as, for example, left to right, or top to bottom.

Exemplary display 500 may further include a zooming tool 510 for providing a zooming capability. In exemplary display 500, zooming tool 510 may include a slider 512 and an indicator 514. In one embodiment, the user may move indicator 514, using a pointing device, to enlarge or reduce a size of digital images in the displayed portion of light box 502. When using zooming tool 510, navigation indicator 508 may increase or decrease in size corresponding to an increase or decrease in a size of the displayed portion of the surface of light box 502.

In other embodiments, the zooming capability may be provided in other ways. For example, in some embodiments, a scroll wheel of a computer mouse, or finger gestures by a user may be used to indicate whether the displayed portion of light box 502 may be enlarged or reduced in size, and by how much. Of course, in other embodiments, other methods may be used to indicate whether the displayed portion of a light box may be enlarged or reduced in size, and by how much.

In various embodiments, there is a concept of a “boundary” around each light box. A user may “enlarge” a light box to explicitly add additional spacing between digital images, or may “shrink” the light box to explicitly eliminate some spacing between the digital images. The user may enlarge or shrink the light box using indicator 514, a scroll wheel of a computer mouse, or via other methods.

Digital images within a light box may be manually grouped and named by a user. FIG. 6 illustrates an exemplary display 600 showing a number of digital images 602 on a surface of a light box. A user may click and drag a pointing device in an area surrounding digital images to be grouped. In some embodiments, the area surrounding the digital images to be grouped may be indicated by a dashed line 604, or by other means. Alternatively, a user may touch a touch screen of display 600 and may drag the pointing device to indicate the area surrounding the digital images to be grouped.

In some embodiments, after the user indicates the digital images to be grouped, a visual indication, such as, for example, a group aura 606, or other visual indication, may be displayed to indicate the digital images included in the group. The user then may provide a name for the group. In exemplary display 600, the name provided for a group surrounded by group aura 606 is “Mom and Dad”. A name 610 provided for a group surrounded by a group aura 608 may be “The Kids”.

In exemplary display 600 group auras 606, 608 may be cloud shaped. However, in other embodiments, group auras may have other shapes, such as, for example, an oval shape, a circular shape, a rectangular shape, an irregular shape, or other shapes.

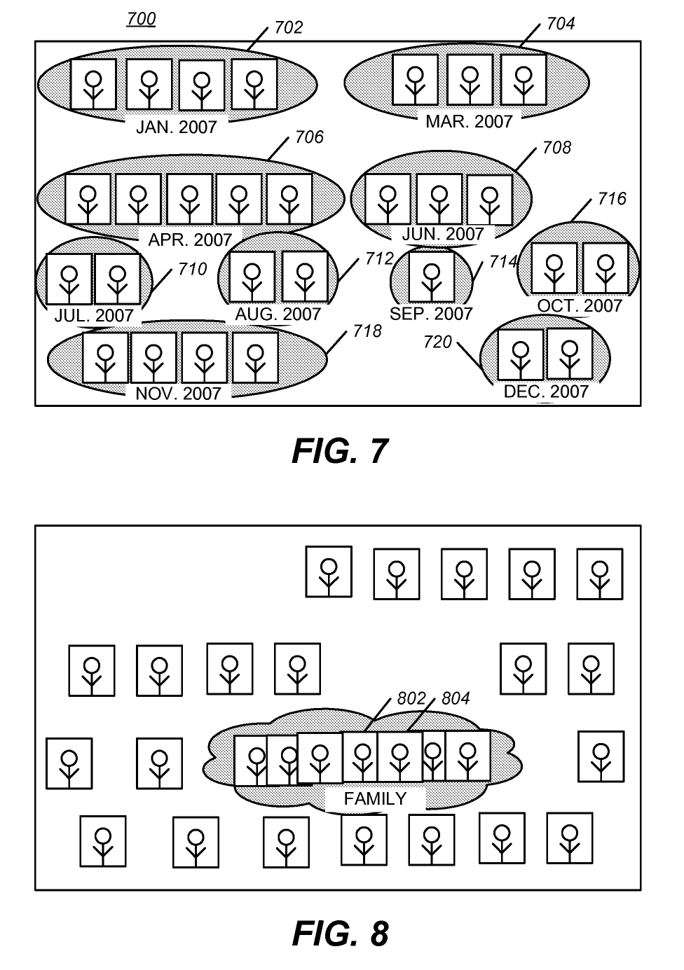

In embodiments consistent with the subject matter of this disclosure, one or more groups of digital images of a light box may be automatically formed based on various criteria, such as, for example, a capture date, a location, a ranking, user-defined metadata, or other criteria. For example, a user may indicate, via a pop-up menu or other method, that groups of digital images are to be formed based on a month in which respective digital images were captured. FIG. 7 illustrates an exemplary display 700, which may be presented after forming groups based on the month in which the respective digital images are captured. Display 700 shows groups 702, 704, 706, 708, 710, 712, 714, 716, 718, 720 including digital images captured during January 2007, March 2007, April 2007, June 2007, July 2007, August 2007, September 2007, October 2007, November 2007, and December 2007, respectively. Each of groups 702-720 may be surrounded by a group aura, which in exemplary display 700 is oval-shaped, but may have another shape in other embodiments, as previously discussed.

Digital images may be added to an existing group of digital images of a light box by moving an individual digital image, multiple digital images or a second existing group of digital images to the existing group of digital images. FIG. 8 corresponds to display 600 of FIG. 6, with digital images of the existing group named “Mom and Dad” moved to the existing group named “The Kids”. A resulting group has been renamed to “Family”. Note that digital images 802, 804, corresponding to the digital images originally included in the group named “Mom and Dad” were dropped into the group now named “Family”. The digital images already included in the group receiving digital images 802, 804 may automatically be moved to make room for digital images 802, 804, such that at least a portion of each of the digital images may be seen. If little or no space exists due to surrounding digital images and/or groups of digital images, one or more of the surrounding digital images and/or groups may be automatically moved to make room for the group having digital images 802, 804 added. In FIG. 8, the resulting group may be surrounded by a cloud-shaped group aura. As mentioned previously, the group aura may have a different shape in other embodiments.

A user may move one or more digital images, or a group of digital images, by using a pointing device. For example, in an embodiment in which a display device includes a touch screen, the user may select a digital image by touching the touchscreen, with the pointing device, at a point where the digital image is displayed, dragging the pointing device to a destination group of digital images, and removing the pointing device from having contact with the touch screen. In embodiments in which the pointing device is a computer mouse, a user may use the computer mouse to cause a cursor to appear over a digital image, click on the digital image, drag the cursor to the destination group, and unclick the computer mouse, thereby causing the digital image to be moved to the destination group of digital images.

To move a group of digital images to a destination group of digital images, the user may use the pointing device to click (or make contact with the touch screen), drag the pointing device to define an area surrounding the group of digital images, drag the pointing device to the destination group of digital images, and unclick the pointing device (or move the pointing device away from the touch screen).

In other embodiments, other methods may be used to move an individual digital image, or a group of digital images to a destination group of digital images.

In some embodiments, when moving one or more digital images, the one or more digital images may appear to be lifted up from a surface of a light box and dropped onto the surface of the light box when placed at a destination on the surface of the light box.

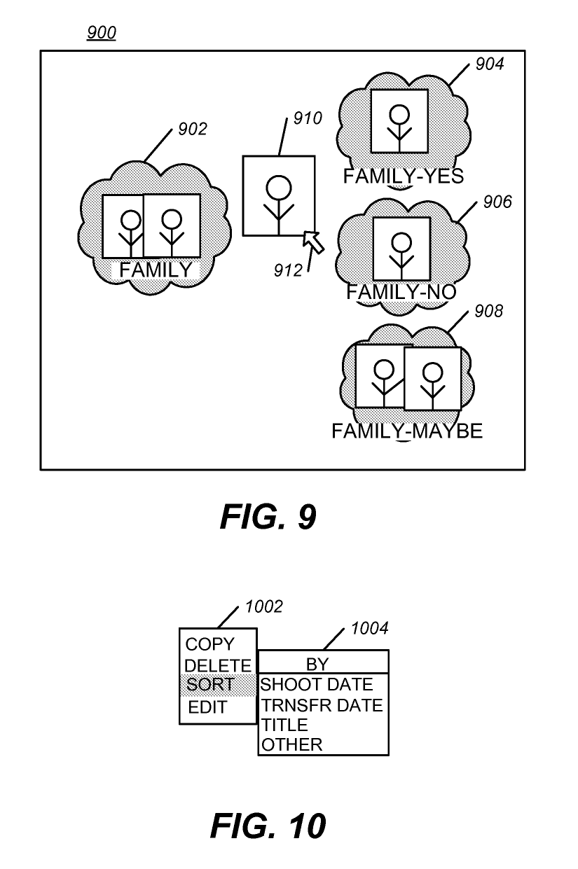

FIG. 9 illustrates an exemplary display 900 showing a group of digital images 902, named “Family”. A user may indicate a desire to categorize digital images included in group 902 via a pointing device, or other method. In some embodiments, when the user indicates a desire to categorize digital images of a group, several new groups may be created. For example, as shown in FIG. 9, three groups may be created. Each of the three groups may be named similarly to the group being categorized. For example, FIG. 9 shows digital images of group 902 being elevated, previewed, and categorized into groups 904, 906, 908, named “Family-yes”, “Family-no”, and “Family-maybe”, respectively. In some embodiments, more than one digital image may be elevated and previewed simultaneously. Initially, groups 904, 906, 908 may have no digital images. The user may move each of the digital images from group 902 to one of groups 904, 906, 908, via any of the methods previously discussed, or other methods. Display 900 shows a digital image 910 being moved to one of groups 904, 906, 908. Display 900 shows digital image 910 being a lifted from a surface of a light box by use of a pointing device. A cursor 912 may be shown moving with digital image 910 in some embodiments. When digital image 910 reaches one of groups 904, 906, 908, digital image 910 may appear to be dropped onto the surface of the light box where the one of groups 904, 906, 908 is positioned. Any digital images included in the one of groups 904, 906, 908 may be automatically moved such that at least a portion of each of the digital images in the one of groups 904, 906, 908 can be viewed. Although, if a user desires, the user may explicitly stack digital images, such that a view of one or more of the digital images may be occluded.

Further, an amount of space between digital images in a group may be adjusted by a user. For example, a user may select “add more space” from a menu to increase an amount of space between the digital images in the group. In one embodiment, an extra 10%-20%, or other amount, of space may be added. Similarly, the user may select “decrease space” from a menu to decrease an amount of space between the digital images in the group. In one embodiment, an amount of space between digital images may be decreased by 10%-20%, or other amount.

Although display 900 shows digital images of a group being categorized into three groups, in other embodiments, digital images of a group may be categorized into fewer than three groups or more than three groups.

Further, in embodiments consistent for the subject matter of this disclosure, digital images of a light box may be categorized into a number of groups. For example, a user may categorize digital images of a light box named “Safari” into a number of groups, such as, for example, groups named “Safari-yes”, “Safari-no”, and “Safari-maybe”.

In some embodiments, metadata may be automatically applied to digital images belonging to specific groups of digital images, if the embodiments are so configured. If digital images are added to one of the specific groups, the metadata may be automatically applied to the added digital images.

Digital images of a light box may be arranged in a sorted formation, such that the digital images may be sorted by respective shoot date, a respective date the digital images were transferred to a processing device (transfer date), a respective title given to the digital images, or other criteria. The user may indicate a desire to arrange the digital images of the light box in a sorted order, or formation, in a number of different ways, such as, for example, by clicking or touching an icon on a display screen, which may cause a menu to appear. FIG. 10 shows an exemplary menu 1002, which may be displayed, when the user indicates a desire to perform an action. In exemplary menu 1002, the user may select a menu item for copying, deleting, sorting, or editing one or more digital images. In exemplary menu 1002, the user may select “sort” and a confirmation may be provided via a visual indication, such as, for example, a menu item corresponding to “sort” being highlighted or shaded. In FIG. 10, upon selecting “sort”, a secondary exemplary menu 1004 may appear having menu items corresponding to sorting criteria. Secondary exemplary menu 1004 may include menu items, such as, for example, a shoot date, a transfer date, a title, or other criteria. Upon selecting one of the menu items of secondary menu 1004, digital images of the light box may be displayed in a sorted formation, or order. Further, in some embodiments, the user may select whether sorting is to be performed in an ascending order or a descending order.

In some embodiments consistent with the subject matter of this disclosure, each group of digital images in a light box may be sorted according to different criteria. For example, a user may select a first group of digital images and may indicate that the first group is to be sorted by a first criteria, such as, for example, a capture date, or other criteria. The user then may select a second group of digital images and may indicate that the second group is to be sorted by a second criteria, such as, for example, metadata associated with each digital image indicating a camera model, or other criteria.

In some embodiments consistent with the subject matter of this disclosure, a user may specify one or more filtering criteria. Digital images of a light box, which satisfy the one or more filtering criteria, may be indicated via a visual indication. For example, digital images, which satisfy the one or more filtering criteria, may appear to be brighter than digital images, which do not satisfy the one or more filtering criteria. In some embodiments, only the digital images, which satisfy the one or more filtering criteria, may be visible, while the digital images, which do not satisfy the one or more filtering criteria may be hidden.

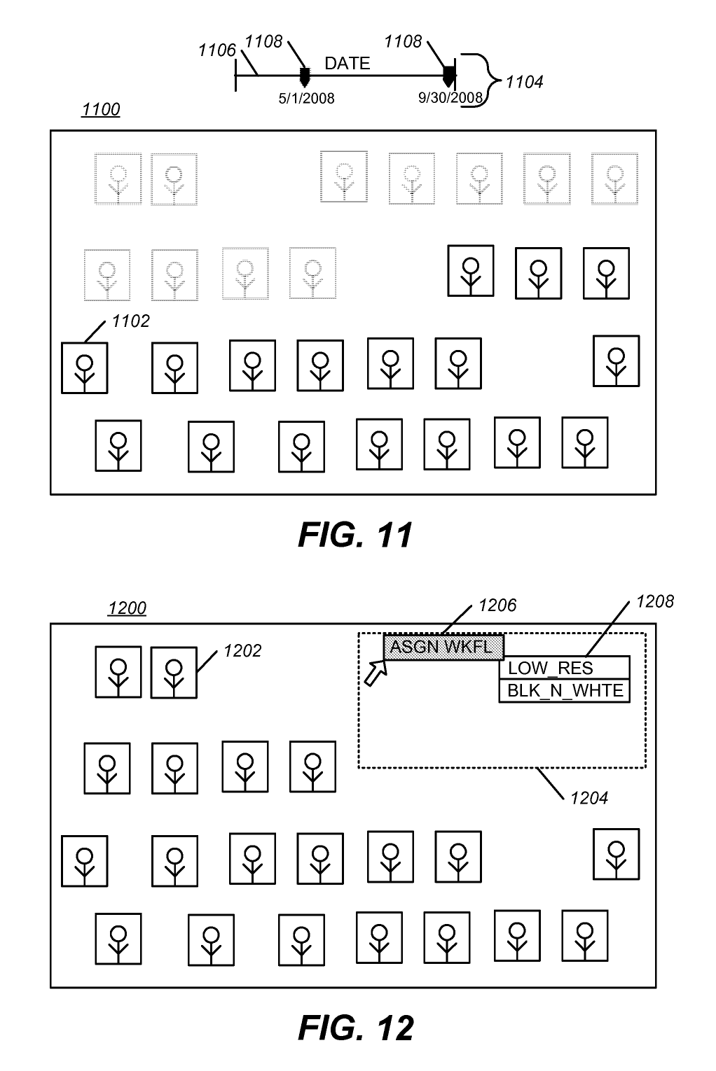

FIG. 11 shows exemplary display 1100, which displays digital images 1102 of a light box and a filtering criteria selector 1104. In exemplary display 1100, filtering criteria selector 1104 may include a slider 1106 and a number of indicators 1108. In this embodiment, slider 1106 may represent a date range. A user may select a date range by moving each of indicators 1108 along a slider 1106. As each indicator 1108 is moved, a date corresponding to a position of a respective indicator may be displayed in a vicinity of the respected indicator. The user may move indicators 1108 in a same manner in which digital images may be moved by using a pointing device. However, indicators 1108 may only be moved along slider 1106. In other embodiments, other methods may be employed for moving indicators 1108.

In FIG. 11, a date range from May 1, 2008 through Sep. 30, 2008 is indicated. As a result of setting a date range of filtering criteria selector 1104, digital images, which satisfy the date range indicated by filtering criteria selector 1104 by, for example, having been captured on a date within the date range, may remain visible, while digital images, which do not satisfy the date range indicated by filtering criteria selector 1104 may be made less visible. As previously mentioned, in some embodiments, the digital images, which do not satisfy the date range indicated by filtering criteria selector 1104, may be hidden.

In various embodiments consistent with the subject matter of this disclosure, a user may define a hot spot, which may be an area on a surface of a light box. The user may assign a workflow to the hot spot. The workflow may be predefined. For example, workflows for decreasing a resolution of a digital image, or for changing a digital image from color to black and white may be predefined. Further, the user may previously define one or more user-defined workflows that may be assigned to the hot spot. The user may assign a workflow to the hotspot, such that when a digital image is moved to the hotspot, the assigned workflow is applied to the moved digital image.

FIG. 12 illustrates exemplary display 1200 having a number of digital images 1202. The user may define a hotspot 1204 by using a pointing device and clicking, or touching, a point on a surface of the light box and dragging the pointing device. A visual indication may be provided to indicate an area of hotspot 1204, such as, for example, a dashed line, or other indication. The user may indicate a desire to assign a workflow to hot spot 1204 by selecting a menu item 1206 from a menu, or via other methods. Upon indicating the desire to assign a workflow to hotspot 1204, a list of predefined workflows 1208 may be displayed. The user may select, with a pointing device, a workflow from the list of predefined workflows. In display 1200, the list of predefined workflows may include a workflow for decreasing a resolution of a digital image, and a workflow for changing a digital image from color to black and white.

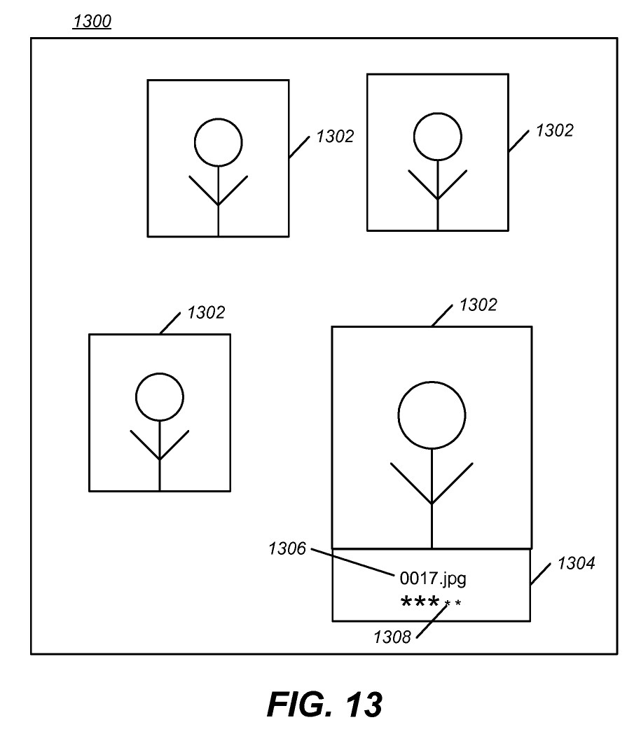

In various embodiments, a user may assign a ranking to one or more digital images of a light box. For example, FIG. 13 shows an exemplary display 1300 of a light box having multiple digital images 1302. The user may select one of multiple digital images 1302 using the pointing device and may indicate a desire to rank the selected digital image by selecting a menu item from a menu, by selecting a display icon on a display, or by other means. After indicating the desire to rank the selected image, image information 1304 may appear adjacent to the selected image. In FIG. 13, image information 1304 may appear below the selected image. In other embodiments, image information may appear in other positions relative to the selected image. Image information 1304 may include an image name 1306 and one or more ranking indicators 1308. In exemplary display 1300, one or more ranking indicators 1308 may be “*”. As a pointing device hovers over each one of one or more ranking indicators 1308, the respective one of the one or more ranking indicators 1308, may be enlarged.

In other embodiments, ranking indicators may be other characters, or shapes. In some embodiments, a color of a ranking indicator may indicate a rank. For example, dark colors may indicate low rankings, while bright colors may indicate high rankings, or vice versa. Further, in other embodiments, a ranking may be indicated by other methods.

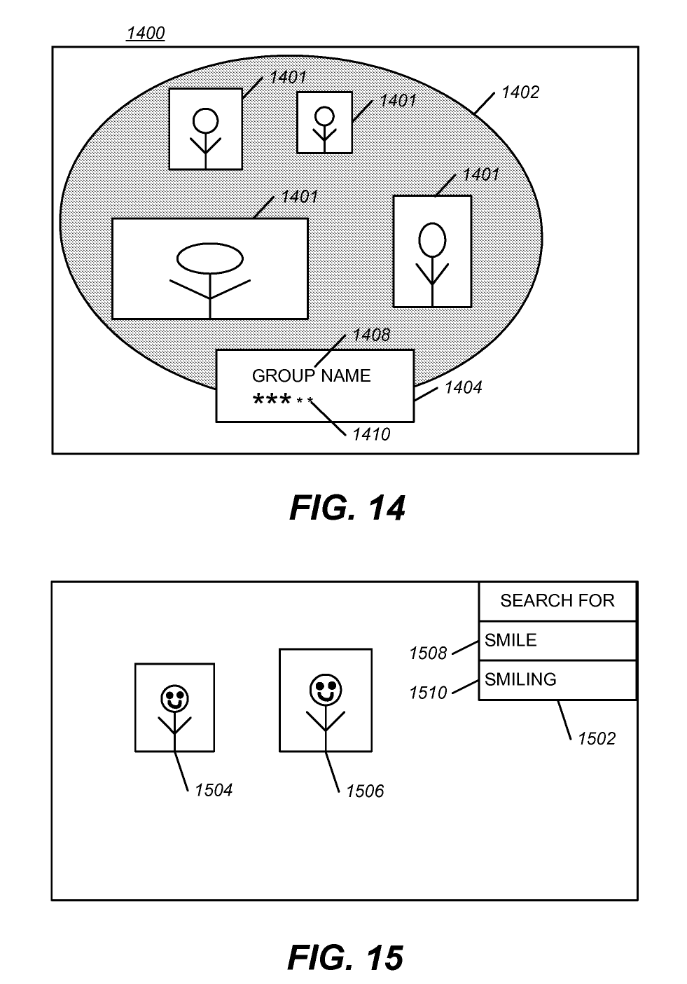

In some embodiments, an entire group of digital images may be assigned a rank. FIG. 14 shows exemplary display 1400 including a group 1402 of multiple digital images 1401. A user may select group 1402 using a pointing device and may indicate a desire to rank selected group 1402 by selecting a menu item from a menu, by selecting a display icon on a display, or by other means. After indicating the desire to rank selected group 1402, group information 1404 may appear in a vicinity of selected group 1402. Group information 1404 may include a group name 1408 and one or more ranking indicators 1410. In exemplary display 1400, one or more ranking indicators 1410 may be “*”. As a pointing device hovers over each one of one or more ranking indicators 1410, a respective one of one or more ranking indicators 1410, may be enlarged. Further, a user may select multiple digital images, either within one or more groups, or outside of any group, and may select a desire to rank the selected digital images. Ranking information for the selected digital images then may be displayed and the user may assign a ranking to the selected digital images, using a pointing device, as described above with respect to groups of digital images, or via another method.

In other embodiments, ranking indicators may be other characters, or shapes. In some embodiments, a color of a ranking indicator may indicate a rank, as previously discussed. In other embodiments, a ranking may be indicated by other methods.

As previously mentioned, digital images may have associated metadata. In a various embodiments, a user may search all digital images of a light box for digital images associated with a particular keyword, or group of key words. FIG. 15 illustrates an exemplary menu 1502, which may be a pop up menu in some embodiments, through which a user may enter one or more keywords, or group of key words 1508, 1510. Further, as mentioned previously, in some embodiments, a user may be able to search across multiple light boxes for digital images associated with the one or more provided particular keywords, or group of keywords 1508, 1510. As a result of searching, digital images 1504, 1506, which have an associated keyword, or group of key words, matching the provided one or more keywords, or group of key words, 1508, 1510, may be displayed.

As previously mentioned, a light box may have associated metadata. The metadata may include, but not be limited to, an aggregation of all metadata associated with digital images included in the light box, as well as additional metadata, such as, for example, light box specific data. As a result of searching light boxes, a search result may be displayed, which may include a representation of one or more light boxes having metadata matching one or more keywords, or groups of keywords of the search.

In various embodiments, a default layout of digital images may be configured. A user may configure a default layout of an embodiment such that, for example, all displayed light boxes may lay out digital images equally-spaced in a grid-like view, all displayed light boxes may automatically group digital images according to some criteria, such as, for example, a month in which the digital images were captured, all displayed light boxes may automatically group digital images, left-to-right, according to a capture time difference among the digital images, or via another layout. The various embodiments may be configured, such that, different light boxes and may have different default layouts. For example, a photographer who takes wedding photos, as well as vacation photos, could configure a light box named “wedding light box” with a default layout configuration to optimize the photographer's wedding work, and a light box named “vacation light box” with a default layout configuration to optimize the photographer's vacation work. If so desired, the user may dynamically change the layout, and/or sort order of the digital images of the light box.

A new light box may be created by selecting “create new light box” from a menu item, by selecting a displayed icon, or via other methods. Upon indicating a desire to create a new light box, a user may be prompted for a name for the light box. Digital images may be added to the light box by selecting one or more digital images from a folder of digital images, and moving the selected digital images to a representation of the light box.

### Exemplary Workflow of a Session

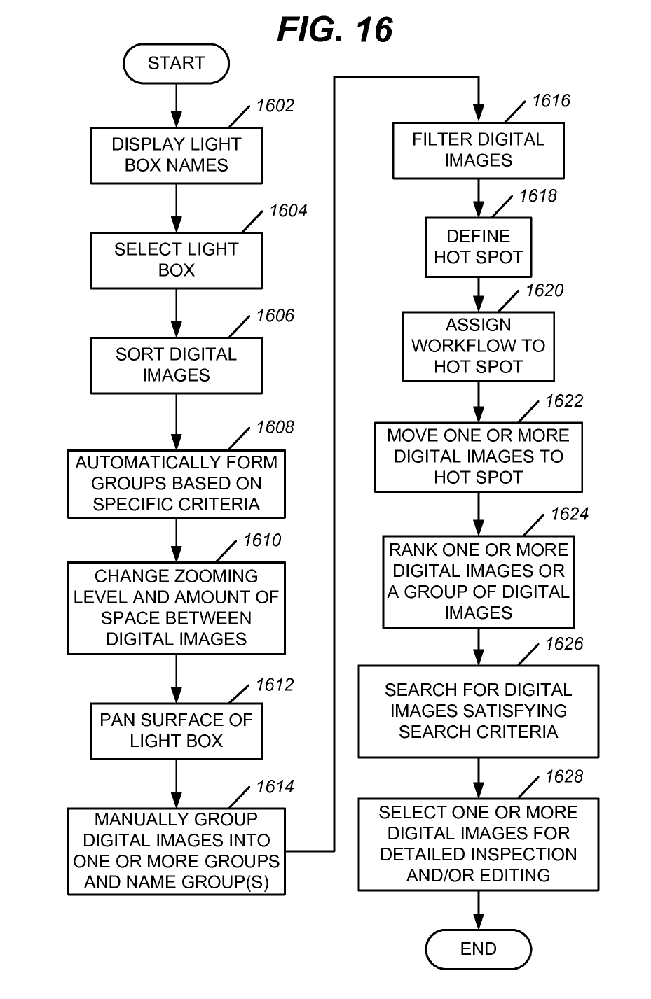

FIG. 16 illustrates an exemplary flow of a user's session with respect to an embodiment consistent with the subject matter of this disclosure. The user's session may begin with a number of a light box names being displayed. The light box names may be displayed in a selectable menu, such as shown in menu 300 (FIG. 3), via a light box browsing display, as shown in FIG. 4, or via another method (1602). The user may select a light box using any of the methods previously discussed, or another method (1604), thereby causing at least a portion of a surface of the selected light box to be displayed. The light box may have a number of digital images positioned on a surface thereof and may be displayed as shown in FIG. 2, or FIG. 5. In some embodiments, the digital images may be positioned on the surface of the light box according to a default layout configured for the light box.

The user may indicate a desire to sort digital images according to selected criteria, thereby causing the digital images to be arranged on a surface of the light box in a sorted formation, or order (1606). Groups of digital images may be formed based on previously selected criteria (1608). At any time, the user may change a zooming level of digital images of the light box and an amount of space between the digital images of the light box (1610). A navigation panel may be displayed showing a position of displayed digital images of the light box in relation to a complete surface of the light box. The user may pan the surface of the light box by moving a navigation indicator of the navigation panel, by clicking and dragging the surface of the light box with a pointing device, or by other methods (1612).

The user may manually group digital images into one or more formed groups and may name, or rename, the one or more formed groups using methods previously discussed, or other methods (1614). Displayed digital images on the surface of the light box may be filtered, such that only ones of the digital images satisfying filtering criteria may be available for other actions, such as, for example, moving, forming groups of digital images, ranking, as well as other actions (1616). Ones of the digital images not satisfying the filtering criteria may appear less visible in a display or may be hidden.

The user may define a hotspot on a surface of the light box (1618) and may assign a workflow to the hotspot (1620). The user may then move one or more digital images on the surface of the light box to the hotspot, thereby causing the assigned workflow to be performed on the one or more moved digital images (1622).

The user may assign a ranking to a digital image, multiple digital images, or a group of digital images (1624). The user may specify search criteria, such as, for example, one or more keywords, metadata values, or other criteria (1626) As a result of the search, digital images having associated metadata, which satisfy the search criteria, may be displayed. The user may select one or more digital images for detailed inspection and editing (1628).

### Conclusion

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Although the above descriptions may contain specific details, they are not be construed as limiting the claims in any way. Other configurations of the described embodiments are part of the scope of this disclosure. Accordingly, the appended claims and their legal equivalents define the invention, rather than any specific examples given.

We claim as our invention:

1. A machine-implemented method for organizing digital images, the machine-implemented method comprising:
providing a light box browsing capability for a user to browse through a plurality of light boxes, each of the plurality of light boxes including a respective plurality of digital images and being displayed as a plane;
permitting a user to select one of the plurality of light boxes;
displaying a portion of a surface of a selected one of the plurality of light boxes in response to the user selecting the selected one of the plurality of light boxes; and
providing organizing assistance for helping the user organize the plurality of digital images of the selected one of the plurality of light boxes.

2. The machine-implemented method of claim 1, wherein the providing of organizing assistance for helping the user organize the plurality of digital images of the selected one of the plurality of light boxes further comprises:
forming a group of at least two digital images from the plurality of digital images of the selected one of the plurality of light boxes.

3. The machine-implemented method of claim 2, wherein the forming of a group of at least two digital images from the plurality of digital images of the selected one of the plurality of light boxes comprises forming the group of the at least two digital images based on specific criteria.

4. The machine-implemented method of claim 1, wherein the providing of organizing assistance for helping the user organize the plurality of digital images of the selected one of the plurality of light boxes further comprises:
sorting the plurality of digital images of the selected one of the plurality of light boxes and arranging respective positions of the plurality of digital images according to a sorted order.

5. The machine-implemented method of claim 1, wherein the providing of organizing assistance for helping the user organize the plurality of digital images of the selected one of the plurality of light boxes further comprises:
filtering the plurality of digital images of the selected one of the plurality of light boxes such that only ones of the plurality of digital images of the selected one of the plurality of light boxes, which satisfy filtering criteria, are displayed and available for one or more actions.

6. The machine-implemented method of claim 1, further comprising:
providing a navigation panel to indicate a position of the displayed portion of a surface of the selected one of the plurality of light boxes with respect to a complete surface of the selected one of the plurality of light boxes.

7. The machine-implemented method of claim 1, further comprising:
permitting the user to move one or more of the plurality of digital images of the selected one of the plurality of light boxes, wherein:
when the one or more of the plurality of digital images is moved, the one or more of the plurality of digital images appears to be lifted from a surface of the selected one of the plurality of light boxes and dropped to a new location, and
surrounding ones of the plurality of digital images of the selected one of the plurality of light boxes are spread out such that the moved one or more of the plurality of digital images does not completely block the surrounding ones of the plurality of digital images from being viewed.

8. The machine-implemented method of claim 1, further comprising:
permitting the user to define a hot spot, the hot spot being an area of a surface of a light box; and
permitting the user to assign a workflow to the hot spot, wherein
when a digital image is moved to the hot spot, the workflow is applied to the digital image.

9. A processing device comprising:
at least one processor; and
a memory connected to the at least one processor and including instructions for the at least one processor, the instructions comprising:
instructions for receiving a selection of one of a plurality of light boxes, each of the plurality of light boxes including a respective plurality of digital images,
instructions for displaying a portion of a selected one of the plurality of light boxes,
instructions for permitting a user to assign respective rankings to ones of the plurality of digital images of the selected one of the plurality of light boxes, and
instructions for forming groups of digital images based on the respective ranks assigned to the ones of the plurality of digital images.

10. The processing device of claim 9, wherein the instructions in the memory further comprise:
instructions for forming a group of digital images based on the user selecting, with a pointing device, an area surrounding ones of the portion of a plurality of digital images to be included in the group,
instructions for adding a digital image to a group of digital images based on the user moving, with the pointing device, the digital image to an area including the group of digital images, and
instructions for moving surrounding digital images and surrounding groups of digital images to make space for displaying the added digital image.

11. The processing device of claim 9, wherein the instructions in the memory further comprise:
instructions for automatically assigning metadata to digital images within a second group of digital images,
instructions for adding a first group of digital images to the second group of digital images in response to the user moving the first group of digital images, with the pointing device, to an area including the second group of digital images, and
instructions for automatically assigning the metadata to the first group of digital images added to the second group of digital images.

12. The processing device of claim 9, wherein the instructions in the memory further comprise:
instructions for editing a digital image of the selected one of the plurality of light boxes.

13. The processing device of claim 9, wherein the instructions in the memory further comprise:
instructions for providing a plurality of zoom levels for displaying ones of a plurality of digital images of the selected one of the plurality of light boxes, and
instructions for increasing or decreasing an amount of space between digital images of the displayed ones of the digital images.

14. The processing device of claim 9, wherein the instructions in the memory further comprise:
instructions for displaying a group aura surrounding a formed group of digital images,
instructions for displaying a group name along with the group aura, and
instructions for renaming the group name of the formed group of digital images.

15. The processing device of claim 9, wherein the instructions for permitting a user to assign respective rankings to ones of the plurality of digital images of the selected one of the plurality of light boxes further comprise:
instructions for permitting the user to assign a first ranking to a formed group of digital images, and
instructions for permitting the user to assign a second ranking to a selected plurality of digital images regardless of whether any of the selected plurality of digital images are included in a group of digital images.

16. A tangible machine-readable medium having recorded thereon instructions for at least one processor, the instructions comprising:
instructions for displaying a portion of a plurality of digital images on a surface of a light box;
instructions for panning the surface of the light box responsive to actions performed via a pointing device;
instructions for zooming in or zooming out with respect to the surface of the light box and the plurality of digital images thereon;
instructions for providing a navigation panel to indicate a position of a displayed portion of the surface of the light box with respect to a complete surface of the light box;
instructions for automatically grouping ones of the plurality of digital images based on predefined criteria or user-defined criteria; and
instructions for searching within the light box, or across multiple light boxes, for ones of a plurality of digital images having metadata satisfying search criteria of the search.

17. The tangible machine-readable medium of claim 16, wherein the instructions further comprise:
instructions for providing a plurality of views of ones of the plurality of digital images in a plurality of formations including a grid, a stack, a sorted formation, and a custom formation, and
instructions for automatically arranging the portion of the plurality of digital images displayed on the surface of the light box according to a pre-configured default layout.

18. The tangible machine-readable medium of claim 16, wherein the instructions further comprise:
instructions for moving a digital image based on actions performed via a pointing device,
instructions for defining a hot spot on the surface of the light box,
instructions for associating a workflow with the hot spot such that the workflow is applied to ones of the digital images moved into the hot spot, and
instructions for assigning a ranking to a selected plurality of digital images regardless of whether any of the selected plurality of digital images are included within a group of digital images.

19. The tangible machine-readable medium of claim 16, wherein the instructions further comprise:
instructions for filtering the plurality of digital images such that only ones of the plurality of digital images which satisfy filtering criteria are available for one or more actions.

20. The tangible machine-readable medium of claim 19, wherein the instructions for filtering the plurality of digital images further comprises:
instructions for providing a visual indication with respect to the ones of the plurality of digital images that satisfy the filtering criteria.
